(19) United States
(12) Patent Application Publication
(10) Pub. No.: US 2001/0016026 A1
(43) Pub. Date: Aug. 23, 2001

(54) Process for producing an absorber element, absorber element and absorber structure

(76) Inventor: Manfred Tennie, Grossostheim (DE)

Correspondence Address: LERNER AND GREENBERG P.A., Post Office Box 2480, Hollywood, FL, 33020-2480, US

(21) Appl. No.: 09/771,913

(22) Filed: Jan. 29, 2001

(30) Foreign Application Priority Data
Jan. 28, 2000 (DE) 100 03 727.5

(51) Int. Cl. G21C 1/04

(52) U.S. Cl. 376/350

(57) ABSTRACT

A process for producing an absorber element, includes applying an absorber layer having an amorphous, metallic base material containing at least one neutron-absorbing element to a support element. The base material, apart from impurities, is formed of nickel, silicon, chromium, iron, at least one neutron-absorbing element and at least one dopant. The absorber layer is formed from at least one foil or at least one sheet which is applied to the support element, in particular by welding. A particularly suitable welding process is the Nd:YAG laser welding process. An absorber element and an absorber structure are also provided.

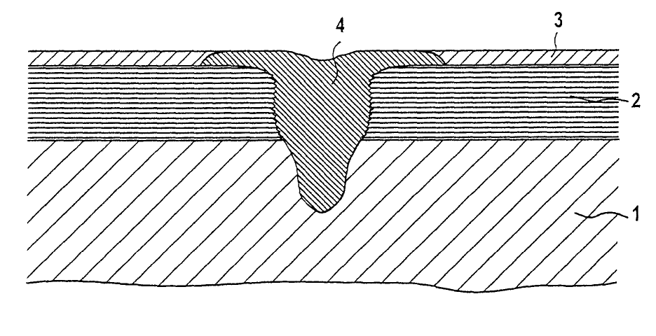

### BACKGROUND OF THE INVENTION

### Field of the Invention

The invention relates to a process for producing an absorber element, also referred to as an absorber structure, in which an absorber layer that includes an amorphous, metallic base material which contains at least one neutron-absorbing element (i.e. a chemical element able to absorb neutrons) is applied to a support element. The invention also relates to an absorber element and an absorber structure.

An absorber element produced using a process of this type is known from German Published, Non-Prosecuted Patent Application DE 197 14 284 A1. There, a foil is applied as absorber layer to a plate-like support element, which can include a metal sheet which is a few millimeters thick. The foil can be attached by welding, for example by butt or seam welding, electron beam welding or laser welding. Other known methods for attaching the foil to the support element are clamping, embossing, rolling, compression or joining operations, such as riveting or stapling. When welding, it has hitherto always been necessary to ensure that the material of the absorber layer does not pass from the amorphous phase into the crystalline phase as a result of heating, since it has been feared that this would cause the material to become brittle.

It is also known for a plurality of layers of the foil to be disposed on top of one another on the support element and for these foils to be interwoven. It is also known for the foils to be covered with a second support element, so that they are disposed in sandwich form between two support elements.

The known foil which serves as an absorber layer is formed, for example, of a chromium-nickel alloy in which boron is incorporated as neutron-absorbing element. This boron may be enriched with the B10 isotope. Other suitable neutron-absorbing elements which can partially or completely replace boron are hafnium, gadolinium or cadmium, as well as the elements with atomic numbers from 58 to 71. All of these elements are distinguished by a large neutron capture cross section.

During production of a known absorber element, there are often difficulties with applying the foil of neutron-absorbing material to the support element. A permanent, secure bond between the foil and the support element has not hitherto been possible.

### SUMMARY OF THE INVENTION

It is accordingly an object of the invention to provide a process for producing an absorber element that overcomes the above-mentioned disadvantages of the prior art methods and devices of this general type, and ensures a secure, permanent attachment between the absorber layer made from amorphous base material and the support element.

With the foregoing and other objects in view there is provided, in accordance with the invention, a process for producing an absorber element, which comprises providing a support element and applying an absorber layer formed from at least one foil or at least one sheet and comprising an amorphous, metallic base material including at least one neutron-absorbing element, and at least one dopant, wherein the base material, apart from at least one neutron-absorbing element and impurities, includes nickel, silicon, chromium, and iron.

With the foregoing and other objects in view there is also provided, in accordance with the invention, an absorber element or absorber structure, comprising a support element and affixed thereto an absorber layer formed from at least one foil or at least one sheet and including an amorphous, metallic base material including at least one neutron-absorbing chemical element, and at least one dopant, wherein the base material, apart from at least one neutron-absorbing element and impurities, includes nickel, silicon, chromium, and iron.

At least one, but generally more, dopants are required for production of the base material.

The process of the invention, in particular the selection of the base material for the amorphous material, provides the advantage that for the first time it is possible to achieve a permanently reliable, secure join between the absorber layer and the support element. It is advantageously possible to produce absorber elements which do not require any maintenance outlay and can therefore be used in a storage pool for fuel elements.

The neutron-absorbing chemical element is, for example, boron. Boron has a relative high neutron capture cross section. The boron can, for example, be enriched with the B10 isotope, which is particularly advantageous since this significantly increases the neutron capture cross section for the same amount of boron in the absorber material.

Examples of other suitable neutron-absorbing elements are hafnium, gadolinium or cadmium, or elements with an atomic number from 58 to 71.

By way of example, the base material can advantageously contain a combination of a plurality of neutron-absorbing elements, e.g. a combination of boron and other suitable elements listed above.

By way of example, the base material, apart from impurities, includes 1 to 4 atom % silicon, 5 to 11 atom % chromium, 7 to 12 atom % iron, at least 22 atom % boron as neutron-absorbing element, at least one dopant, and the remainder nickel.

These percentage proportions of the individual elements in the base material provide the advantage that the absorber layer can be securely and permanently attached to the support element.

By way of example, the base material is doped with molybdenum and/or titanium. Suitable doping makes it possible to produce a base material which has particularly good flow properties during the production process. Consequently, an absorber element is particularly simple to produce.

The absorber layer is, for example, welded onto the support element. An Nd:YAG laser welding process or a similar welding process is particularly suitable. A combination of the selection of elements for the base material and a particularly suitable welding process for attaching the absorber layer to the support element has the advantage that a secure and permanent attachment is permanently ensured. This is particularly important when the absorber element is used in a fuel storage pool.

By way of example, the absorber layer is covered by a cover sheet which is spot-welded to the support element. In the process, the absorber layer which lies between them becomes crystalline at some points and is joined to both the cover sheet and the support element. The fact that the absorber layer between the cover sheet and support element becomes crystalline is deliberately accepted.

Overcoming the widely held view that the amorphous absorber layer must not become crystalline at any point has the advantage that support element, absorber layer and cover sheet can be reliably and stably joined to one another. For this purpose, spot welds have to be applied at various points distributed over the surface of the absorber element.

It has been found that, with the selected composition of the base material, the individual crystalline locations in the absorber layer do not impair the required property of the absorber element, even with regard to corrosion problems. A reliable bond between the components of the absorber element is ensured.

The spot-welding leads to the formation of a bond which is similar to a rivet and is able to withstand the high mechanical stresses.

By way of example, it is possible for a plurality of strips of foil to be processed to form a woven sheet which is then applied to the support element as absorber layer, covering this element. For this purpose, the individual foil strips are, for example, interwoven. This has the advantageous result that the absorber layer includes at least two separate layers which are connected to one another.

By way of example, a plurality of support elements and a plurality of absorber layers can be disposed alternately on top of one another. The result is an absorber element which has a particularly good shielding action.

The process according to the invention has the particular advantage that it is possible to produce an absorber element in which the absorber layer adheres stably and reliably to the support element. The absorber element produced is distinguished by the fact that it can be used for a long period reliably and without maintenance.

Other features which are considered as characteristic for the invention are set forth in the appended claims.

Although the invention is illustrated and described herein as embodied in a process for producing an absorber element, an absorber element and an absorber structure, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWING

The FIGURE of the drawing is a fragmentary, diagrammatic, sectional view of an absorber element according to the invention.

### DESCRIPTION OF THE PREFERRED EMBODIMENTS

Referring now in detail to the single FIGURE of the drawing, there is seen an absorber element which is composed of a support element 1, an absorber layer 2 and a cover sheet 3. The absorber layer 2 is formed of an amorphous, metallic base material which, apart from impurities, is formed of 1 to 4 atomic % silicon, 5 to 11 atomic % chromium, 7 to 12 atomic % iron, at least 22 atomic % boron as neutron-absorbing element, at least one dopant, which may be molybdenum or titanium, remainder nickel.

The absorber layer is welded onto the support element 1 using a Nd:YAG laser welding process. The absorber layer 2 is covered by a cover sheet 3 which is spot-welded to the support element 1. The absorber layer 2 between them has in the process become crystalline at certain points, with the result that crystalline rivets join the cover sheet 3 to the support element 1. The absorber layer 2, which is otherwise amorphous, is interrupted by the welded rivets 4. However, the welded rivets 4, which are only required at relatively great intervals, have practically no adverse effect on the efficiency of the absorber layer 2. On the other hand, the welded rivets 4 do allow simple and reliable attachment of the absorber layer 2 to the support element 1.

The absorber layer 2 can be formed from a plurality of foil strips which are interwoven.

The absorber layer 2 can also be composed of a plurality of foils. It is also possible for a plurality of support elements 1 and a plurality of absorber layers 2 to be disposed alternately on top of one another.

While the support element 1 and the cover sheet 3 is formed of standard steel, the absorber layer 2 is generally composed of a chromium-iron-nickel-silicon alloy, to which a neutron-absorbing element, generally boron, is added.

The process according to the invention can be used to construct absorber elements with a long-term stability from which it is possible to produce, for example, a spent fuel rack.

I claim:

1. A process for producing an absorber element, which comprises:
providing a support element and applying to said support element an absorber layer formed from at least one foil or at least one sheet and including an amorphous, metallic base material having at least one neutron-absorbing element, and at least one dopant, said base material, apart from said at least one neutron-absorbing element and impurities, including nickel, silicon, chromium and iron.

2. The process according to claim 1, wherein said neutron-absorbing element is boron.

3. The process according to claim 2, which further comprises enriching the boron with the B10 isotope.

4. The process according to claim 1, wherein said base material contains a combination of a plurality of neutron-absorbing elements.

5. The process according to claim 1, wherein said base material, apart from impurities, includes 1 to 4 atom % silicon, 5 to 11 atom % chromium, 7 to 12 atom % iron, at least 22 atom % boron as a neutron-absorbing element, at least one dopant, and a remainder of nickel.

6. The process according to claim 1, wherein said dopant is at least one of molybdenum and titanium.

7. The process according to claim 1, which further comprises welding said absorber layer onto said support element.

8. The process according to claim 7, which further comprises welding said absorber layer onto said support element using an Nd:YAG laser welding process.

9. The process according to claim 1, which further comprises covering said absorber layer by a cover sheet spot-welded to the support element, causing said absorber layer to become crystalline at some points and thus join both said cover sheet and said support element.

10. The process according to claim 1, which further comprises forming said absorber layer from a plurality of interwoven foil strips.

11. The process according to claim 1, which further comprises placing a plurality of support elements and a plurality of absorber layers alternately on top of one another.

12. An absorber element produced by the process according to claim 1.

13. An absorber structure, comprising:
a support element and an absorber layer affixed to said support element, said absorber layer formed from at least one foil or at least one sheet and including an amorphous, metallic base material having at least one neutron-absorbing element, and at least one dopant, and said base material, apart from said at least one neutron-absorbing element and impurities, including nickel, silicon, chromium and iron.

14. The absorber structure according to claim 13, wherein said neutron-absorbing element is boron.

15. The absorber structure according to claim 14, wherein the boron is enriched with the B10 isotope.

16. The absorber structure according to claim 14, including at least one additional neutron-absorbing element selected from the group consisting of hafnium, gadolinium, cadmium and elements having an atomic number from 58 to 71.

17. The absorber structure according to claim 13, wherein said base material, apart from impurities, includes 1 to 4 atom % silicon, 5 to 11 atom % chromium, 7 to 12 atom % iron, at least 22 atom % boron as a neutron-absorbing element, at least one dopant selected from the group consisting of molybdenum and titanium, and a remainder of nickel.

18. The absorber structure according to claim 13, wherein said absorber layer is welded onto said support element.

19. The absorber structure according to claim 13, including a cover sheet covering said absorber layer and spot-welded to the support element, causing said absorber layer to become crystalline at some points and thus join both said cover sheet and said support element.

20. The absorber structure according to claim 19, including crystalline rivets joining said cover sheet and said support element.

21. The absorber structure according to claim 13, wherein said absorber layer is formed from a plurality of interwoven foil strips.

22. The absorber structure according to claim 13, wherein a plurality of support elements and a plurality of absorber layers are disposed alternately on top of one another.
